(19) United States
(12) Patent Application Publication
(10) Pub. No.: US 2021/0194340 A1
(43) Pub. Date: Jun. 24, 2021

(54) METHOD FOR MANUFACTURING SHAPED RODS

(71) Applicant: MIBA AUTOMATION SYSTEMS GES.M.B.H., Laarkirchen (AT)

(72) Inventors: Andreas FALKNER, Weis (AT); Mladen-Mateo PRIMORAC, St. Polten (AT); Gerhard EHGARTNER, Laakirchen (AT)

(21) Appl. No.: 17/273,499

(22) PCT Filed: Sep. 10, 2019
(86) PCT No.: PCT/AT2019/060293

§ 371 Date: Mar. 4, 2021

(30) Foreign Application Priority Data
Sep. 12, 2018 (AT) A50780/2018

(51) Int. Cl. H02K 15/04; H02K 3/12; H02K 3/28

(52) U.S. Cl. CPC H02K 15/0428; H02K 3/28; H02K 3/12

(57) ABSTRACT

A method for manufacturing shaped rods from shaped-rod blanks, for use in electrical machines. The method includes preparing the shaped-rod blanks, and shaping the shaped-rod blanks on a goods carrier.

### CROSS-REFERENCE TO RELATED APPLICATIONS

The present application is a National Stage Application of PCT International Application No. PCT/AT2019/060293 (filed on Sep. 10, 2019), under 35 U.S.C. § 371, which claims priority to Austrian Patent Application No. A50780/2018 (filed on Sep. 12, 2018), which are each hereby incorporated by reference in their complete respective entireties.

### TECHNICAL FIELD

The present disclosure relates to a method for manufacturing shaped rods for use in electrical machines, and a manufacturing system for manufacturing shaped rods.

### BACKGROUND

As is known, electrical machines, such as motors or generators, have windings. In addition to conventional coils made from round wire, there are also so-called flat-wire, spiral-wound technology and hairpin technology in which, instead of an endless wire, shaped rods are also used. Currently, the shaped rods used for this technology are manufactured individually from endless material, wherein the individual shaped-rod blanks pass through the manufacturing line one after the other. That method is therefore associated with high cycle times and the resulting disadvantages.

### SUMMARY

This invention is based on the task of being able to manufacture shaped rods more efficiently for the windings of electrical machines.

This task of the invention is realized with the method specified in the introduction in that multiple shaped rods are positioned and fixed on a goods carrier prior to the shaping and are shaped together on the goods carrier.

The task is further realized with the method for manufacturing shaped-rod blanks, according to which it is provided that the conductor wire is provided with notches prior to the separating device, whereby the conductor wire is fed through at least one vertical notcher roller pair and at least one horizontal notcher roller pair.

The task of the invention is further realized with the manufacturing system specified in the introduction, in which the manufacturing system also has at least one goods carrier, on which multiple shaped-rod blanks can be arranged, and on which the shaped-rod blanks can be shaped simultaneously.

The task of the invention is also realized with the specified manufacturing system for manufacturing shaped-rod blanks, which has at least on vertical notcher roller pair and at least one horizontal notcher roller pair.

The present disclosure relates to a method for manufacturing shaped rods for use in electrical machines, and comprises the steps of: preparing the shaped-rod blanks and shaping the shaped-rod blanks.

The present disclosure also relates to a method for manufacturing shaped-rod blanks for the manufacturing of shaped rods for use in electrical machines, wherein the shaped-rod blanks are manufactured from a conductor wire, whereby the conductor wire is fed with a wire feeding device to a separating device.

The present disclosure further relates to a manufacturing system for manufacturing shaped rods for use in electrical machines, wherein the manufacturing system has a shaping station for the shaping of shaped-rod blanks.

The present disclosure also relates to a manufacturing system for manufacturing shaped-rod blanks for the manufacturing of shaped rods for use in electrical machines, comprising a wire feeding device and a separating device.

Here, it is advantageous that with the arrangement of the shaped-rod blanks on a goods carrier, it is possible to decouple the preparation of the shaped-rod blanks at least partially from the shaping with respect to processing, i.e., these processes can be performed in parallel or simultaneously. Decoupling also means that slower processes can be decoupled from quicker processes, whereby bottleneck problems can be better managed during production. Consequently, the cycle time for manufacturing a shaped rod can be shortened. Further acceleration of the processing can be achieved through the simultaneous shaping of multiple shaped-rod blanks. Thus, overall, cycle times for manufacturing a shaped rod can be achieved that are in the range of tenths of a second. Consequently, the output of electrical machines can also be high accordingly, whereby the production of electric motors for e-mobility becomes more interesting economically. With the method for manufacturing shaped-rod blanks or the manufacturing system here for, shaped-rod blanks can be manufactured at a high rate, whereby the high-volume manufacturing of shaped rods is further supported.

According to one preferred design variant of the invention, it can be provided that the shaped-rod blanks are shaped with the goods carrier as a tool. For this purpose, according to one design variant of the manufacturing system, it can be provided that the goods carrier is designed as a shaping tool for the shaped-rod blanks, wherein, according to one design variant, it can be provided that the goods carrier is designed with at least two parts, wherein at least two parts are connected to each other by means of a common swivel axle, and receptacle areas for the shaped-rod blanks are formed on each of the two parts. With these design variants, further simplification of the manufacturing of the shaped rods can be achieved, because the shaped-rod blanks do not also have to be manipulated for the shaping. In addition, the “goods carrier” tool is easily formed, whereby its tool life can also be increased.

According to another design variant of the invention, it can be provided that insulation is stripped at least partially from multiple shaped rods on the goods carrier. In this way, additional shortening of the cycle time can also be achieved by avoiding additional manipulation work.

Preferably, the insulation stripping of the shaped-rod blanks takes place in an insulation-stripping station that is arranged prior to the shaping station in the production direction, because, in this way, the shaped-rod blanks are still straight and the insulation stripping can be performed more quickly.

The insulation-stripping station can be formed, according to another design variant of the manufacturing system, for holding the goods carrier with the multiple shaped-rod blanks located on the carrier, whereby further shortening of the cycle time can be achieved. If necessary, multiple shaped-rod blanks can also be processed simultaneously.

It is advantageous if, according to one design variant, the insulation-stripping station has at least one rotating device for rotating the goods carrier, because, in this way, only one insulation-stripping tool is required for stripping insulation from both ends of the shaped-rod blanks.

For quicker positioning of the shaped-rod blanks, according to another design variant of the invention, it can be provided that the goods carrier has recesses, wherein each recess is formed for holding one shaped-rod blank.

According to another design variant of the invention, it can be further provided that the vertical notcher roller pair and/or the horizontal notcher roller pair touches the conductor wire only within the range of a contact angle from 5° to 20° and is moved in sync with the conductor wire during the associated time period. Due to the only short contact of the notcher roller(s) with the conductor wire, the precision of the notches can be improved.

According to one design variant, it can also be provided that the vertical notcher roller pair and/or the horizontal notcher roller pair is/are moved more slowly or more quickly outside of the time period during which this pair/these pairs is/are moved in sync with the conductor wire. For this purpose, the vertical notcher roller pair and/or the horizontal notcher roller pair can have its own drive mechanism. This makes it possible shaped-rod blanks with different lengths can be manufactured at a high rate according to the same method and especially with the same manufacturing system.

Preferably, according to another design variant, it can be provided that the notches have a rounded shape. This can make it easier to insert the shaped rods into the stator lamination stack, in particular, thereby also preventing damage to the insulation paper. If insulation is later applied to the wire ends, e.g., by immersion or powder sintering, thin location in the insulation layer can also be avoided at sharp edges. Due to the rounded edges, the layer thickness remains approximately constant. In this way, arcing can be better avoided at high voltages.

According to another design variant, however, it is also possible for two side edges of the shaped-rod blanks formed one next to the other to be left with sharp edges, whereby the welding of the shaped rods can be improved. For this purpose, the vertical notcher roller pair and/or the horizontal notcher roller pair can be provided with only one blade and the other roller can have only a supporting function.

For reducing the tolerances, according to another design variant of the invention, it can be provided that a distance that the conductor wire covers is defined. For this purpose, the manufacturing system can be equipped with an encoder friction gear.

For better understanding of the invention, it will be explained in more detail with reference to the following figures.

### DRAWINGS

Shown, each in greatly simplified, schematic representation, are:

FIG. 1 is a schematic of a manufacturing system for manufacturing shaped-rod blanks;

FIG. 2 is a design variant of a shaped rod;

FIG. 3 is another design variant of a shaped rod;

FIG. 4 is a design variant of a goods carrier;

FIG. 5 is another design variant of a goods carrier;

FIG. 6 is another design variant of a goods carrier;

FIG. 7 is a detail of one design variant of the shaping station of the manufacturing system;

FIG. 8 is a goods carrier;

FIG. 9 is a section from a shaping tool in its opened state;

FIG. 10 is a section from the shaping tool in its closed state;

FIG. 11 is a shaping tool in a first shaping position;

FIG. 12 is the shaping tool according to FIG. 11, in a second shaping position;

FIG. 13 is a section from another shaping tool in a perspective view from the side;

FIG. 14 is a section from the additional shaping tool in a view from above;

FIG. 15 is a section from a different shaping tool;

FIG. 16 is a schematic representation of a device for manufacturing shaped-rod blanks; and

FIG. 17 is two shaped rods connected to each other in plan view.

### DESCRIPTION

As an introduction, it should be noted that in the different embodiments described, identical parts are provided with identical reference symbols or identical part designations, wherein the statements disclosed in the entire description can be transferred analogously to identical parts with identical reference symbols or identical part designations. The positional information chosen in the description, e.g., top, bottom, side, etc., refer to the figure being described at that time and in the event of a change in position, this positional information is to be transferred analogously to the new position.

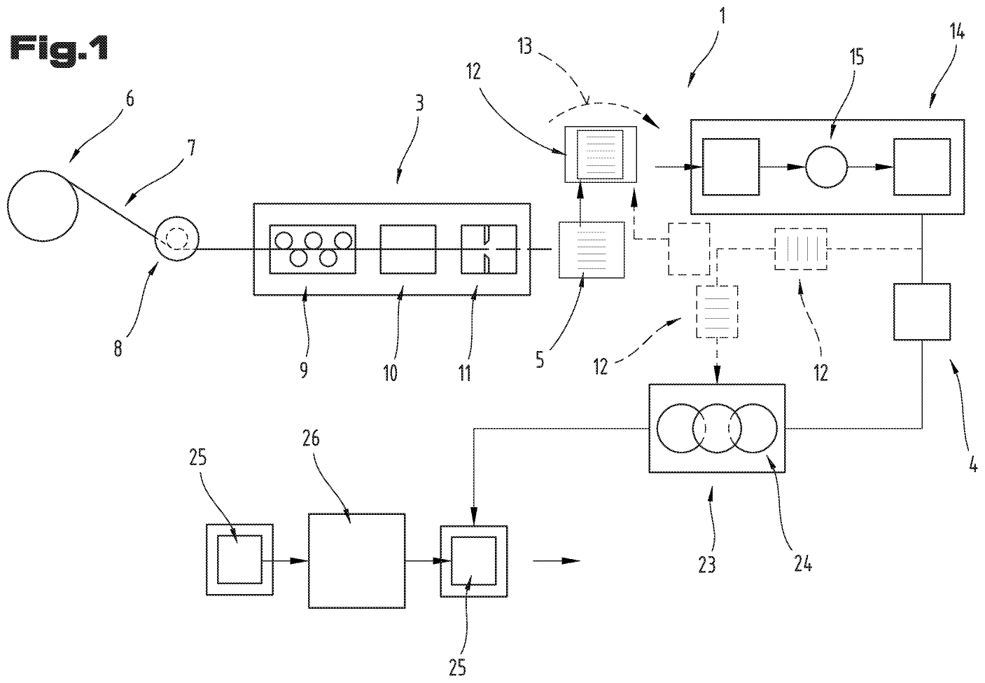

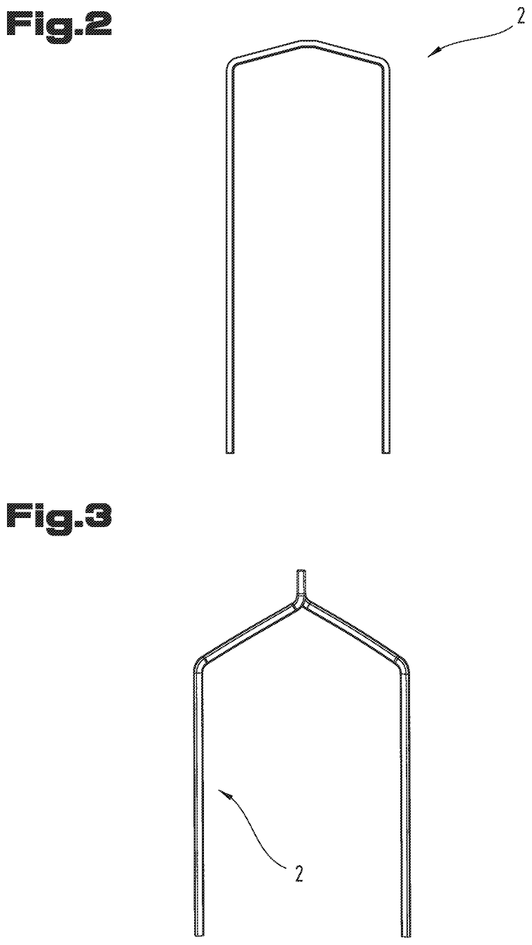

In FIG. 1, a schematic representation shows a manufacturing system 1 for manufacturing shaped rods 2 for use in electrical machines, such as electric motors or generators. Examples of such shaped rods 2 are shown in FIGS. 2 and 3. It should be noted, however, that the shapes shown do not restrict the invention. Instead, other shapes from the relevant state of the art are also known and are included in reference here.

The manufacturing system 1 can be part of an overall system for manufacturing assemblies of such electrical machines, for example, for manufacturing stators, as shown in FIG. 1.

The manufacturing system 1 comprises a preparation station 3 and a shaping station 4.

In the preparation station 3, shaped-rod blanks 5 are prepared for further processing. For this purpose, the preparation station has multiple processing zones.

The raw material for manufacturing shaped rods 2 is typically unwound or pulled from a reel 6 in the form of an already coated (finished) conductor wire 7 and fed via a roller 8 to the preparation station. Obviously, other designs of feeding mechanisms are possible for the conductor wire 7.

The conductor wire 7 preferably has a rectangular or square cross-sectional shape, wherein other cross-sectional shapes, e.g., circular or oval or trapezoidal, can also be used.

In the preparation station, the conductor wire 7 can be fed in a first step to an alignment zone 9. In the alignment zone 9, e.g., the cross-sectional shape can be corrected and/or the conductor wire 7 can be straightened.

The conductor wire 7 can be further fed into an embossment zone 10, in particular, (immediately) after the alignment zone 9.

In the direction of production, after the embossment zone 10 (especially immediately after), there is a cutting zone 11 in which the conductor wire 7 is cut into lengths to form the shaped-rod blanks 5.

Because this type of preparation of the shaped-rod blanks 5 is known from the state of the art, reference is made to this prior art in order to avoid repetition.

At the end of the preparation station there are shaped-rod blanks 5 of a certain length. These shaped-rod blanks 5 are fed to the shaping station 4. For this purpose, multiple shaped-rod blanks 5 are arranged on a goods carrier 12, for example, pushed onto this carrier by means of a slide feed.

At this transfer zone of the shaped-rod blanks 5 from the preparation station 3 onto the goods carrier 12, there is also preferably the previously mentioned decoupling of the slower processing steps from the quicker processing steps.

With the goods carrier 12, multiple shaped-rod blanks 5 can be fed together to the shaping station 4 for further processing. If necessary, the shaped-rod blanks 5 can also be rotated in advance by 90° in the plane, as shown in FIG. 1 with reference to the arrow of rotation 13.

A preferred design variant of the manufacturing system 1 is shown in FIG. 1; an insulation-stripping station 14 is shown prior to the shaping station 4 in the direction of production.

The at least partial insulation stripping of the shaped-rod blanks 5 is required for forming contacts to the shaped rods 2. In principle, this insulation stripping can take place in a known way, by feeding each shaped-rod blank 5 individually to the insulation-stripping station. In the scope of the invention, however, multiple shaped-rod blanks 5 can also be fed on the goods carrier 12 together to the insulation-stripping station 14, as shown in FIG. 1.

In the insulation-stripping station 14, insulation is stripped from at least the two end areas of each shaped-rod blank 5, i.e., the previously mentioned coating layer is removed. For this purpose, the known tools can be used, which are described, for example, in the relevant state of the art, as referenced here in this context.

Preferably, the at least partial insulation stripping of the shaped-rod blanks 5 is performed with a laser.

Because the shaped-rod blanks 5 are also preferably processed already on the goods carrier 12 in the insulation-stripping station 14, the insulation-stripping station 14 is designed accordingly for holding the goods carrier 12, for example, equipped with a corresponding feeding device, on which the goods carrier is transported.

It can be further provided that in the insulation-stripping station 14 there is at least one rotating device 15 for rotating the goods carrier 12. Alternatively or additionally, however, the goods carrier 12 can also have a rotating device (on the bottom side), so that additional rotating devices for rotating the shaped-rod blanks 5 or the goods carrier 12 can be optionally eliminated in the manufacturing system 1.

In the preferred design variant of the manufacturing system 1, multiple shaped-rod blanks 5 on the goods carrier 12 are transferred to the shaping station 4.

In the shaping station 4, shaped-rod blanks 5 are shaped, for example, into the U-shape shown in FIG. 2 or into another known shape or hairpin shape. For the shaping, the shaped-rod blanks 5 remain on the goods carrier 12, so that multiple shaped-rod blanks 5 are shaped simultaneously.

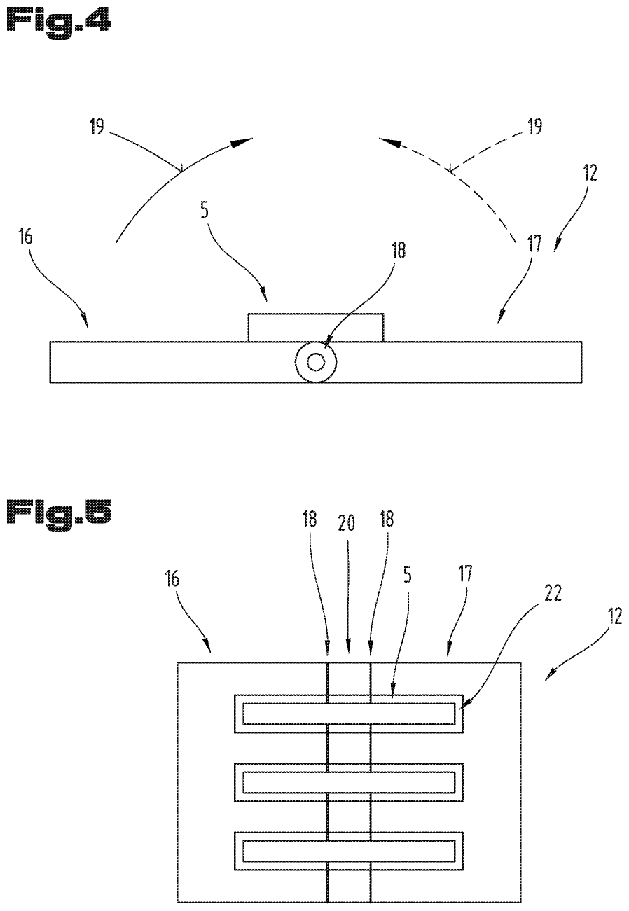

Here, preferably according to one design variant of the manufacturing system 1 it can be provided that the goods carrier 12 is used itself as a shaping tool. The goods carrier 12 can have, for example, a two-part design, as shown in FIG. 4, which shows a goods carrier 12 in a lateral view. Accordingly, a first goods carrier part 16 can be connected to a second goods carrier part 17 by means of a joint 18. Each of the shaped-rod blanks 5 is arranged both on the first and also on the second goods carrier parts 16, 17. For the shaping, at least one of the two goods carrier parts 16, 17 is pivoted relative to the other goods carrier part 17, 16 according to arrow 19; thus, the two goods carrier parts 16, 17 are folded together like a book. Here, both goods carrier parts 16, 17 can also be pivoted, as shown in FIG. 4 with reference to the dashed arrow 19. By “folding together,” all the shaped-rod blanks 5 on the goods carrier 12 are shaped simultaneously. After the shaping, the goods carrier 12 is opened again by the opposite motion (thus, “the book is folded open again”).

The two goods carrier parts 16, 17 can have an identical size design. However, it is possible for the goods carrier 12 to have a different partitioning, i.e., of the surface on which the shaped-rod blanks 5 are arranged.

It is further possible that the goods carrier is divided into more than two goods carrier parts 16, 17 that can pivot relative to each other. This is intended to be represented in FIG. 5, in which a three-part goods carrier 12 is shown in plan view. The goods carrier 12 here comprises the two goods carrier parts 16, 17 that are connected to another goods carrier part 20 by means of a joint 18 (only indicated). The middle, additional goods carrier part 20 has a narrower design than the two other goods carrier parts 16, 17. For the shaping of the shaped-rod blanks 5, this middle, additional goods carrier part 20 can be left stationary, if necessary, and only the two other goods carrier parts 16, 17 are pivoted.

In general, it is applicable that each of the shaped-rod blanks 5 is arranged on each of the goods carrier parts 16, 17, 20, if only one row of shaped-rod blanks 5 is shaped together. This is not the case if more than one row of shaped-rod blanks 5 is on the goods carrier 12.

It should be noted, however, that the representations of the goods carrier 12 in FIGS. 4 and 5 are merely examples. Other designs of the goods carrier 12 are possible within the scope of the invention.

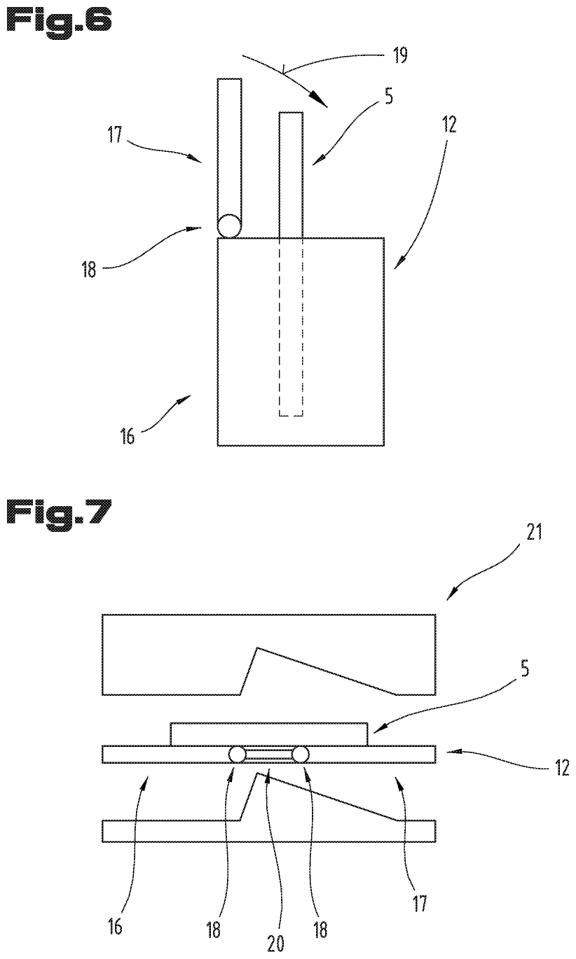

In FIGS. 4 and 5, the shaped-rod blanks 5 are arranged lying horizontally on the goods carrier 12. A different, e.g., upright arrangement of the shaped-rod blanks 5 is also possible, as shown in FIG. 6, which also shows, for the sake of simplicity, a goods carrier 12 with one two parts. For this design variant of the goods carrier 12, the goods carrier part 16 has recesses in which the shaped-rod blanks 5 are arranged upright. The shaped-rod blanks 5, however, are longer than the recesses, so that they project past the goods carrier part 16 and thus can be shaped with the goods carrier part 17 by pivoting about the joint 18.

For the movement of the individual goods carrier parts 16, 17, 20, the shaping station 4 has corresponding movement devices, e.g., actuators or motors, which are not shown in the figures.

In principle, the common shaping of the shaped-rod blanks 5 can also be performed with other methods, in which the goods carrier functions only in this way and not as a shaping tool. As an example of this arrangement, a joint 21 is shown in FIG. 7. The goods carrier 12 is here used only for storing and holding the shaped-rod blanks 5. The latter are inserted on the goods carrier 5 between the die parts of the die 21 and shaped by the closing movement of the die 21. So that the goods carrier can also perform the shaping movement, it has a multiple-part design, for example, it is provided with the goods carrier tiles 16, 17, 20 connected to the joint 18.

It is also possible that the shaped-rod blanks 5 are gripped with a manipulator and shaped by the movement of the manipulator while being fixed on the goods carrier 12.

In general, the shaped-rod blanks 5 are fixed on the goods carrier 12 at least during the shaping and optionally during the insulation stripping. Preferably, however, the shaped-rod blanks 5 are fixed on the goods carrier during the entire time period in which they are located on the goods carrier 12. For fixing, typical fixing mechanisms can be provided, e.g., (spring-loaded) locking plates or bars, etc.

For fixing and/or positioning the shaped-rod blanks 5, according to another design variant of the manufacturing system 1 it can be provided that the goods carrier 12 has recesses 22, wherein each recess 22 is designed to hold one shaped-rod blank 5, as shown in FIG. 5. The recesses 22 can have a shape and size (cross-sectional area seen in plan view) that corresponds to the shape and size of the shaped-rod blanks 5 (viewed in the same direction). They can further have a depth that is dimensioned so that the shaped-rod blanks are arranged flush with the remaining surface of the goods carrier 12 in which the recesses 22 are formed.

After the shaping of the shaped-rod blanks 5, these can leave the manufacturing system 1 and can be removed from the goods carrier 12.

For the sake of completeness, it should be noted that multiple goods carriers 12 with shaped-rod blanks 5 can be located simultaneously in the manufacturing system 1.

With the manufacturing system 1, shaped rods 2 can be prepared for use in electrical machines, which were manufactured from shaped-rod blanks 5 according to one method, wherein this method comprises the steps of preparing the shaped-rod blanks 5 and shaping the shaped-rod blanks 5 corresponding to the preceding statements. Here, multiple shaped-rod blanks 5 are positioned on a goods carrier 12 prior to the shaping and shaped together on the goods carrier 12.

According to one variant of the method, the goods carrier 12 itself can be used as the tool for shaping the shaped-rod blanks 5.

According to another variant of the method, it can also be provided that insulation is stripped at least partially from multiple shaped-rod blanks 5 on the goods carrier 12.

As already stated above, the manufacturing system 1 for manufacturing the shaped rods 2 can be part of an overall system with which parts of electrical machines are manufactured using the shaped rods 2, e.g., stators. For this purpose, shaped rods 2 can also be rotated, if necessary, to form the desired hairpin shape that is shown as an example in FIG. 3.

The shaped rods 2 can then be joined in a cage-forming station 23 to form a shaped-rod cage, wherein multiple transfer plates 24, which form the shaped-rod cage by pivoting the rods by 180°, can be arranged in the cage-forming station 23.

The shaped rod cage is then inserted into notches of a lamination stack 25, which was previously likewise fed to a notch insulation station 26, if necessary.

It can be further provided that shaped rods 2 with a special shape are required for forming the shaped rod cage. For this purpose, these rods can be treated separately and sorted after the insulation stripping and fed to the cage-forming station 23 on a separate goods carrier 12 (shown with dashed lines in FIG. 1).

In FIGS. 9 to 11, a design variant of a goods carrier 12 is shown with a shaping tool 27 (partially only as a section). The shaping tool 27 is preferably part of the goods carrier 12.

The goods carrier 12 can have two side holding elements 28, 29 with which multiple shaped-rod blanks 5 can be held. The holding elements 28, 29 can have a strip-like shape. However, they can also have a different shape.

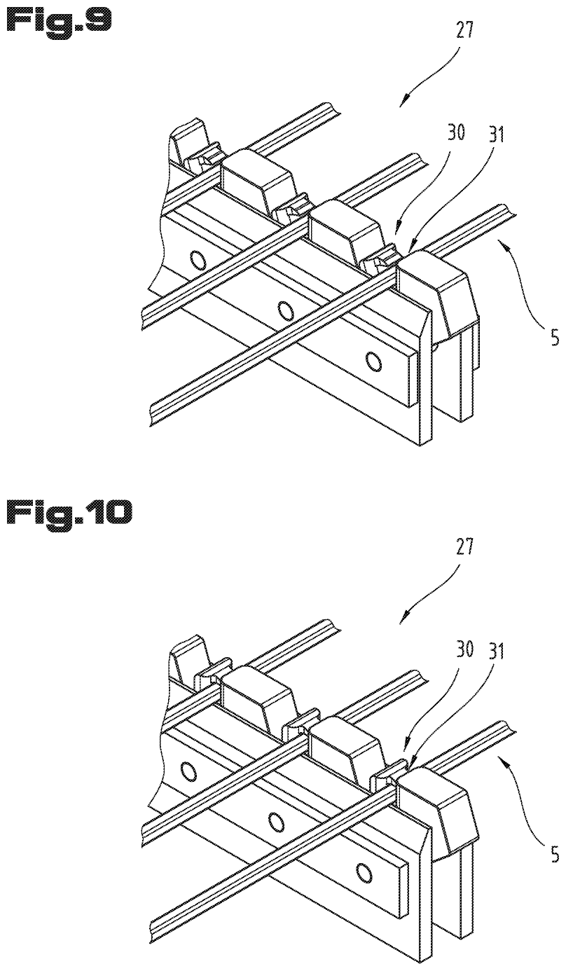

The shaping tool 27 for shaping the shaped-rod blank 5 also has at least one holding element 30 and/or fixing element for each shaped-rod blank 5, as is better visible from FIGS. 9 and 10. These holding elements 30 and/or fixing elements have a hook-shaped or L-shaped design in the shown design variant of the shaping tool 27 and are mounted so that they can pivot. The pivoting motion is possible at least between an open position and a closed position. In the open position that is shown in FIG. 9, the shaped-rod blanks 5 can be placed in the shaping tool 27 for processing. In the closed position, which is shown in FIG. 10, the holding elements 30 and/or fixing elements contact the shaped-rod blanks 5 for their processing, in particular, shaping processing, in the manufacturing system 1 (FIG. 1), preferably at least partially. The holding elements 30 and/or fixing elements can be pivoted between a position (FIG. 9) releasing receptacles 31 for the shaped-rod blanks 5 and a position (FIG. 10) closing these receptacles 31.

The holding elements 30 and/or fixing elements for the shaped-rod blanks 5 can also have a different design, for example, as clamping jaws, etc.

In the shown design of the goods carrier 12, the shaping tool 27 can be arranged in the middle between the two holding elements 28, 29 of the goods carrier 12. Depending on the shaping to be performed, the shaping tool 27 could also be placed differently. There is also the possibility that more than one shaping tool 27 is provided or arranged.

If the at least one shaping tool 27 is not part of the goods carrier 12, the goods carrier 12 is placed such that the shaped-rod blanks 5 engage accordingly in the shaping tool 27 for the shaping, as shown in the figures.

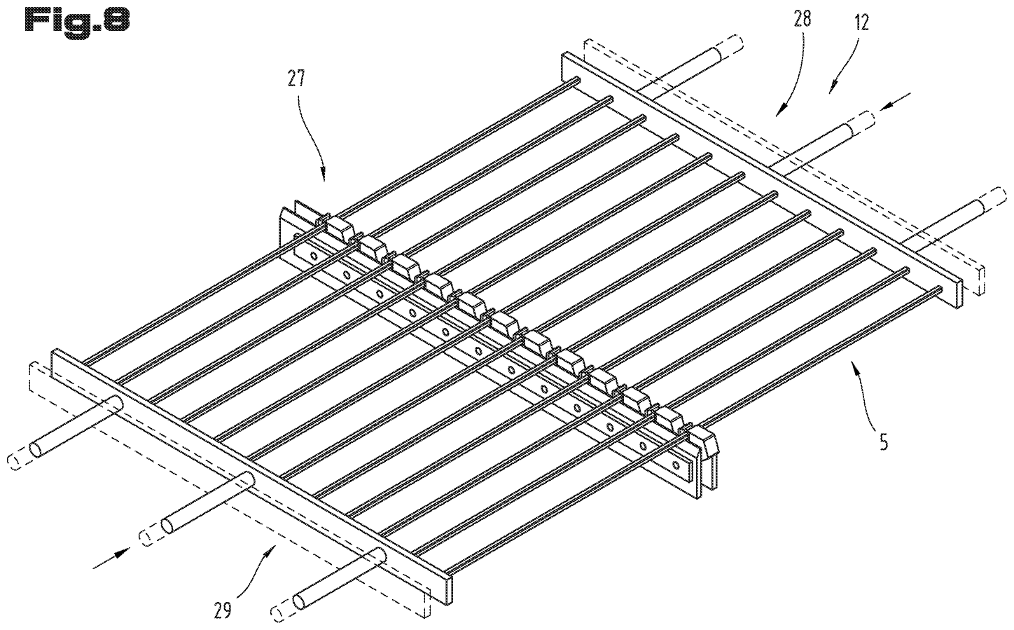

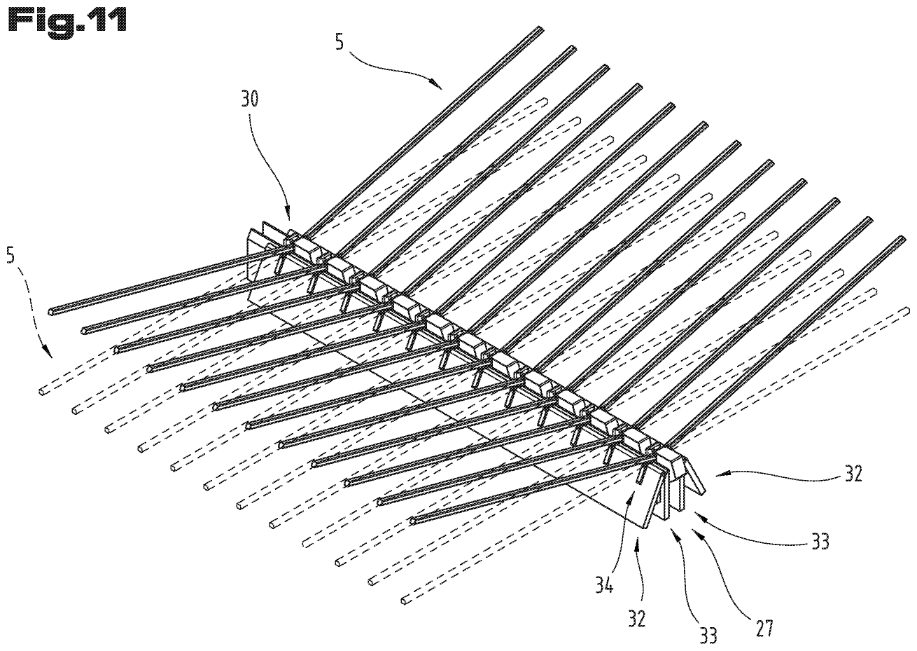

By holding or fixing the shaped-rod blanks 5 with the shaping tool 27, a first shaping can be performed on these blanks, which is shown in FIG. 11. Here, the shaped-rod blanks 5 are bent (in the middle) by moving the ends of the shaped-rod blanks, e.g., upward (for example, with the two holding elements 28, 29 (FIG. 8) of the goods carrier 12). For illustrating the shaping, the shaped-rod blanks 5 are shown in FIG. 11 both in the straight original state and also in the shaped state. The shaping is here realized by bending the shaped-rod blanks 5 by means of the holding elements 30 and/or fixing elements.

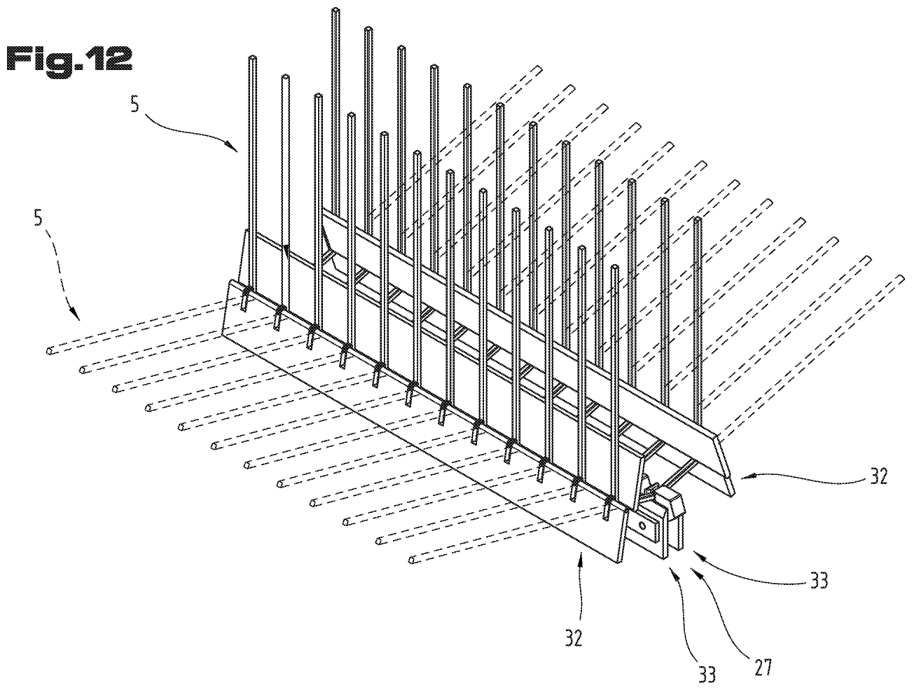

In FIG. 12, another shaping step for manufacturing the hairpin shape is shown. Here, the ends of the shaped-rod blanks 5 are each bent upward, so that the shaped-rod blanks 5 are given the approximate appearance of hairpins. The original situation is, in turn, like what exists after the first shaping according to FIG. 11, and the final state after this second shaping is shown.

For this shaping, the shaping tool 27 (or optionally a separate, additional shaping tool) can be provided with pivoting shaping flaps 32. The shaping flaps 32 have a joint connection to the holding flaps 33. Preferably, the shaping flaps 32 have a slot-shaped receptacle 34 for each shaped-rod blank 5, which can be better seen from FIG. 11. The shaped-rod blanks 5 are shaped by the pivoting of the shaping flaps 33 (upward). Here, the shaped-rod blanks 5 are moved into the preferably arranged slot-shaped receptacles 34, whereby the shaped-rod blanks 5 are supported during the shaping process.

The slot-shaped receptacles 34 extend starting from one side edge over a partial area of the width of the shaping flaps 33, as can be seen from FIG. 11.

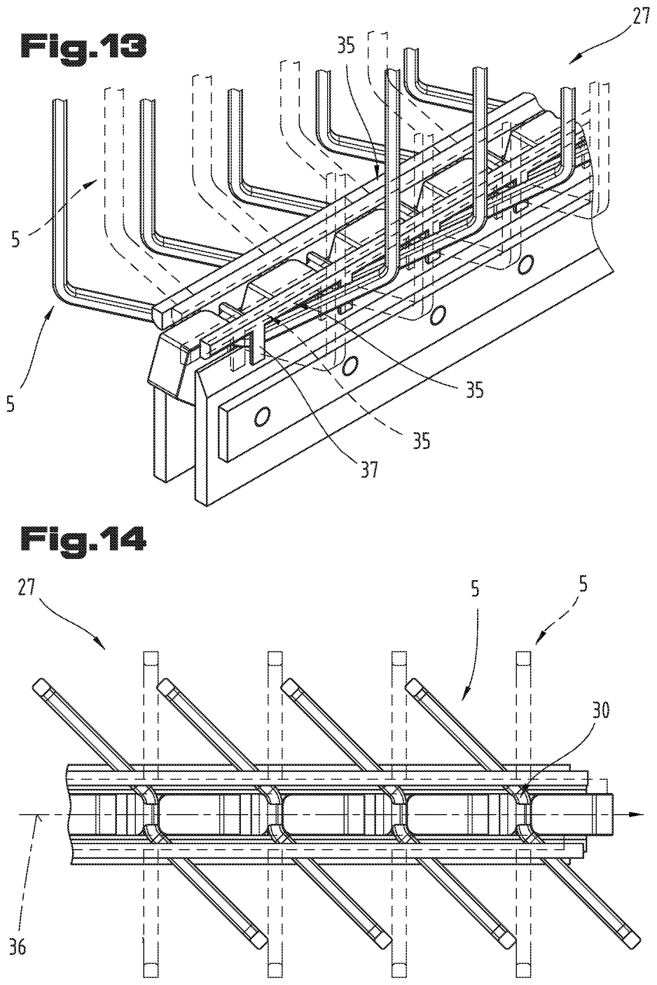

In FIGS. 13 and 14, another design variant of the shaping tool 27 is shown in a section view. This shaping tool 27 can also be optionally part of the goods carrier 12.

The shaping tool 27 preferably also has the holding elements 30 and/or fixing elements for holding and/or fixing the shaped-rod blanks 5. In addition, the shaping tool 27 has comb-like shaping elements 35 that can move in the direction of a longitudinal axis 35. By moving at least one of these shaping elements 35 in the direction of the longitudinal axis 36, the shaped-rod blanks 5 are shaped by tines 37 of the shaping element 35 (or the shaping elements 35), whereby the shaped-rod blanks 5 are shaped into an S-shape (S-stroke), as can be seen from FIG. 14.

FIG. 15 shows a section from another design variant of the shaping tool 27. This shaping tool 27 can also include the previously described design variants of the shaping tool 27, that is, in particular, the holding elements 30 and/or the fixing elements and/or the comb-shaped shaping elements 35 and/or the shaping flaps 32 or the holding flaps 33.

The shaping tool 27 according to FIG. 15 has gripping elements 38 that are mounted so that they are jointed or can pivot and can be used to grip the shaped-rod blanks 5 and shape these blanks into an arc shape. For this purpose, these gripping elements 38 are arranged on shaping bars 39. The shaping bars 39 can be moved in the direction of the longitudinal axis 36.

At this point, it should be mentioned that the shaped-rod blanks 5 can generally be held on the goods carrier 12 with gripping elements 38 mounted with such jointed connections.

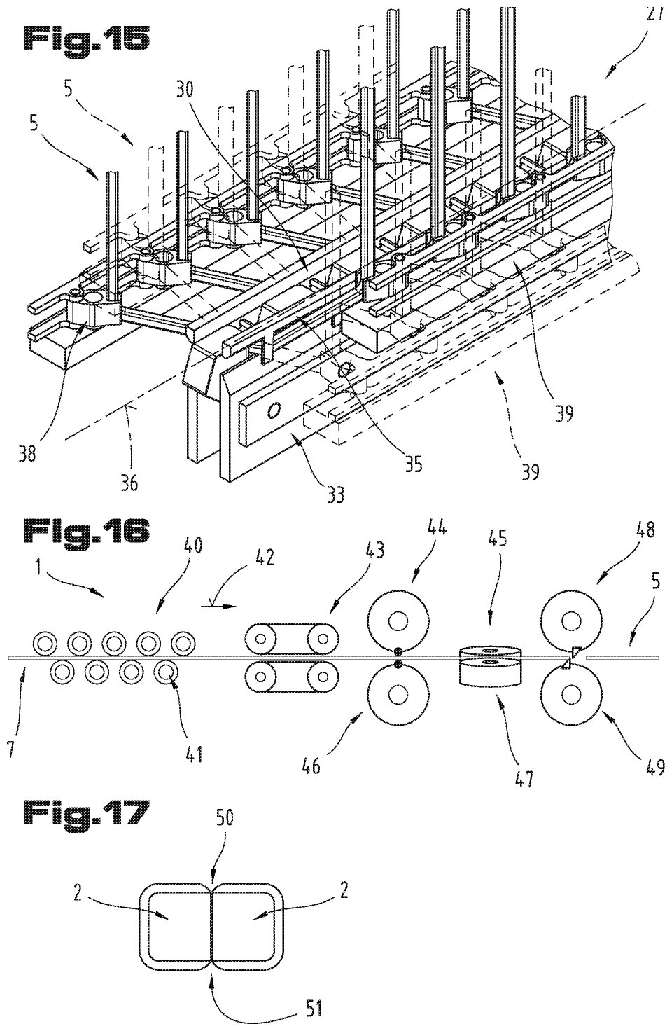

In FIG. 16, the manufacturing of shaped-rod blanks 5 from a conductor wire 7 is shown schematically in a preferred design variant of the manufacturing system 1. In this way, shaped rods 2 (or generally wire pieces) can be manufactured from the endless, in particular, rectangular conductor wire at a high rate and with a variable length. So that the shaped rods 2 have rounded edges on both ends, they are provided with a notch (optionally on all sides) at the cutting point prior to the cutting.

The manufacturing system 1 can have a feeding mechanism for the conductor wire 7 (coil unwinding, not shown) and a buffer section (loop depository, not shown) prior to an alignment station 40 in which the conductor wire 7 is aligned. The alignment station can be provided with multiple alignment rollers 41 corresponding to the state of the art. In a feeding mechanism 42 of the conductor wire 7 through the manufacturing system 1, a wire feeding mechanism 43 is preferably arranged after the alignment station 40. The wire feeding mechanism 43 is preferably formed as a belt feeding mechanism but could also be formed by other drive mechanisms. With the wire feeding mechanism 43, the conductor wire is fed/moved continuously through the manufacturing system 1.

Arranged after the wire feeding mechanism 43 in the direction of feed 42 is a vertical notcher roller pair 44 and a horizontal notcher roller pair 45. The sequence could also be reversed, that is, the horizontal notcher roller pair 45 is arranged in front of the vertical notcher roller pair 44. In addition, more than one vertical notcher roller pair 44 and/or more than one horizontal notcher roller pair 45 can be arranged, even if this is not the preferred design variant of the manufacturing system 1.

In the vertical notcher roller pair, there are notcher rollers 46 arranged with their axis of rotation horizontal. In the horizontal notcher roller pair 45, there are notcher rollers 47 arranged with their axis of rotation vertical accordingly.

Arranged after the notcher roller pairs 44, 45 in the direction of feed 42 is a separating mechanism 48 with cutting rollers 49 (cutting wheels).

The processing of the conductor wire is thus realized essentially in three steps: indent a notch on one or both sides, indent a notch offset by 90°, cut the conductor wire 7 to length.

With this manufacturing system, shaped-rod blanks 5 can be manufactured for manufacturing shaped rods for use in electrical machines, wherein the shaped-rod blanks are manufactured from the conductor wire 7, whereby the conductor wire 7 is fed with the wire feeding mechanism 43 to the separating mechanism 48, wherein the conductor wire 7 is provided with notches prior to the separating mechanism 48, whereby the conductor wire 7 is fed to at least to at least one vertical notcher roller pair 44 and at least one horizontal notcher roller pair 45.

According to one preferred design variant of the invention, it can be provided that the vertical notcher roller pair 44 and/or the horizontal notcher roller pair 45 contact the conductor wire 7 only over a short area. Here, “only over a short area” means that the notcher rollers 46 and/or 47 contact the wire only within an area of a contact angle from 5° to 20°, in particular, 5° to 10°. The contact angle is referenced to one complete revolution of 360° of the notcher rollers 46 and/or 47. During the associated time span, the notcher rollers 46 and/or 47 are moved (rotated) in sync (at the same speed) with the conductor wire 7.

Over the remainder of the circumference of the notcher rollers 46 and/or 47 (that is, in the range from 340° to 355°), the notcher rollers 46 and/or 47 preferably do not contact the conductor wire 7. In this way, the notcher rollers 46 and/or 47 according to another design variant of the invention can be operated at a faster or slower speed. This can be utilized, in turn, to manufacture shorter or longer shaped-rod blanks 5. The manufacturing system 1 thus can be used for manufacturing shaped-rod blanks 5 with variable lengths, and in a continuous manufacturing method for shaped-rod blanks 5.

The vertical notcher roller pair 44 and/or the horizontal notcher roller pair 45 can (each) have a separate drive mechanism (not shown).

For sparing engine power, it can be provided that the cutting roller diameter (cutting wheel diameter) is matched to the length of the shaped-rod blanks 5 to be manufactured. For example, the shortest shaped rods 2 for a small electric motor could be approx. 160 mm. Within a manufacturing system 1, the shaped rod length differs by a factor of approx. 2, that is, up to approx. 320 mm. If one takes the average, that is, 240 mm, this produces a cutting roller diameter of 240/π=76.4 mm. The cutting roller must then be driven with increased or decreased rotational speed in the range where it is not in contact and coupled to the assembly line speed during contact.

For a different, larger motor, the shaped rod lengths vary from 400 mm to 700 mm, which then gives a cutting roller diameter of 175 mm.

With a cutting roller diameter matched to the average of the shaped rod lengths, engine power can be spared, because the acceleration and deceleration phases can be reduced.

All of the side edges of the shaped-rod blanks 5 can have a rounded design, so that notches are generated with a radius. However, according to another design variant of the invention, it can be provided that two side edges 51, 52 formed one next to the other on the shaped-rod blanks 5 are left with sharp edges, as shown in FIG. 17, which shows, simplified, a plan view of two shaped rods 2 welded to each other. For the welding, especially laser welding, it can be advantageous if the ends have sharp edges on adjacent positions. For realizing this design variant, the vertical notcher roller pair and/or the horizontal notcher roller pair are provided with only one blade roller and the other roller has only a supporting function.

According to one design variant, the blades for manufacturing the notches can also move and can be activated or deactivated as needed. This provides an additional degree of freedom for being able to arbitrarily arrange the notches.

In order to keep the tolerances of the lengths of the shaped-rod blanks 5 as small as possible, it can be provided that the wire feeding mechanism 43, especially the assembly line feeding drive, feeds the conductor wire 7 with relatively low slippage. Additionally or alternatively, the conductor wire preferably moves at a constant speed in order to rule out dynamic effects. Only the acceleration or deceleration of the notcher rollers 46, 47 and cutting rollers 49 is then still dynamic, which, however, are no longer at this point in time still in contact with the wire.

For further improving length tolerances, it can be provided that an encoder friction wheel or generally a dynamometer or a speed measuring device is also arranged in the manufacturing system 1. In this way, a distance that covers the conductor wire 7 can be defined.

A small conductor wire length when the notches are formed can be compensated by parameter configurations in software.

All or multiple drives can be coupled with each other with a CNC controller with high-resolution incremental sensors.

In summary, the manufacturing system 1 has the advantage that the length of the shaped-rod blanks 5 is variable and can be set separately for each shaped rod 2. The shaped-rod blanks 5 can be manufactured continuously with turning tools. For this purpose, four roller pairs can be provided, namely a drive roller pair, two notcher roller pairs 44, 45, and one separating roller pair. The drive roller pair runs preferably at a constant rotational speed (the speed could also be variable, if necessary, e.g., for adjusting to the following processes, if these do not run completely continuously) and generates a constant feed rate of the conductor wire 7. The notcher roller pair 44 with horizontal axis presses a notch into the conductor wire 7 on one side or both sides. The second notcher roller pair 45 with vertical axis likewise presses a notch into the conductor wire 7 on one side or both sides. Preferably, three sides of the shaped-rod blank 5 are rounded on both sides and the fourth side is left with an (almost) sharp edge, in order to simplify the insertion of the shaped rods 2 into the stator and not to produce thin points of insulation at sharp edges later during the coating process. With the separating roller pair, the shaped-rod blank 5 is separated from the conductor wire 7. The two notcher roller pairs 44, 45 and the separating roller pair move preferably only during contact in sync with the conductor wire 7, in between more slowly or more quickly, depending on the desired shaped rod length. In this way, each shaped rod 2 can obtain a different length individually, despite a high processing rate.

The matching can be performed, for example, as follows:

1. In the preparation station 3, a shaped rod 2 is prepared every 0.25 s.

2. 8 shaped rods 2 are set on a goods carrier 12 one after the other.

3. Then the goods carriers 12 cycle with a cycle time of 2 s.

4. The distance of the shaped rods 2 is dimensioned so that, in the laser delamination station, all 8 rod ends can be reached by the laser scanner and processed in one pass.

Depending on requirements, multiple such stations can be arranged one after the other, if necessary with turning stations connected in-between, in which all eight shaped rods 2 are turned simultaneously by 90° or 180°.

It should be noted, however, that the specified cycle times and the number of shaped-rod blanks 5/shaped rods 2 per goods carrier 12 are only examples. Preferably, however, the goods carriers 12 cycle at eight-times the cycle time of the shaped rod preparation process.

Despite the very short cycle times, a separate length can be generated for each rod.

In another design variant of the invention, the die 21 can have a segmented design. While the goods carrier 12 cycles, the individual segments can be set and then fixed differently. In this way it is possible to generate a separate bending shape for each individual rod.

The embodiments show or describe possible design variants of the manufacturing system 1, wherein it should be noted as this point that also combinations of the individual design variants with each other are possible.

Finally, as a matter of form, it should be noted that for better understanding of the setup of the manufacturing system 1 or the goods carrier 12, these are not necessarily shown true to scale.

### LIST OF REFERENCE SYMBOLS

1 Manufacturing system
2 Shaped rod
3 Preparation station
4 Shaping station
5 Shaped-rod blank
6 Reel
7 Conductor wire
8 Roller
9 Alignment zone
10 Embossment zone
11 Cutting zone
12 Goods carrier
13 Arrow of rotation
14 Insulation-stripping station
15 Turning device
16 Goods carrier part
17 Goods carrier part
18 Joint
19 Arrow
20 Goods carrier part
21 Die
22 Recess
23 Cage-forming station
24 Transfer plate
25 Lamination stack
26 Notch isolation station
27 Shaping tool
28 Holding element
29 Holding element
30 Holding element
31 Receptacle
32 Shaped flap
33 Holding flap
34 Receptacle
35 Shaping element
36 Longitudinal axis
37 Tine
38 Gripping element
39 Shaping bar
40 Alignment station
41 Alignment roller
42 Feeder device
43 Wire feeder device
44 Notcher roller pair
45 Notcher roller pair
46 Notcher roller
47 Notcher roller
48 Separating device
49 Cutting roller
50 Side edge
51 Side edge

1-20. (canceled)

21. A method for manufacturing shaped rods for use in electrical machines, the method comprising:
preparing a plurality of shaped-rod blanks;
positioning and fixing the shaped-rod blanks on a goods carrier; and
shaping the shaped-rod blanks on the goods carrier.

22. The method of claim 21, wherein shaping the shaped-rod blanks comprises shaping the shaped-rod blanks using the goods carrier as a shaping tool.

23. The method of claim 21, further comprising, after positioning and fixing the shaped-rod blanks on a goods carrier but prior to shaping the shaped-rod blanks, stripping insulation at least partially from the shaped-rod blanks on the goods carrier.

24. A method for manufacturing shaped-rod blanks composed of conductor wire for use in electrical machines, the method comprising:
providing notches on the conductor wire; and
feeding, via a wire feeding device, the conductor wire to a separating device, wherein the conductor wire is fed through at least one vertical notcher roller pair and at least one horizontal notcher roller pair.

25. The method of claim 24, wherein the vertical notcher roller pair and/or the horizontal notcher roller pair touches the conductor wire only within a range of a contact angle of between 5° to 20°, and is moved in sync with the conductor wire during an associated time period.

26. The method of claim 25, wherein the vertical notcher roller pair and/or the horizontal notcher roller pair is/are moved more at a reduced speed or an increased speed outside of the associated time period during which the vertical notcher roller pair and/or the horizontal notcher roller pair is/are moved in sync with the conductor wire.

27. The method of claim 25, wherein the notches have a rounded shape.

28. The method of claim 25, wherein two side edges of the shaped-rod blanks formed next to each other are left with sharp edges.

29. The method of claim 25, wherein a distance that the conductor wire covers is predefined.

30. A manufacturing system for manufacturing shaped rods composed of conductor wire for use in electrical machines, the manufacturing system comprising:
a shaping station for shaping the shaped-rod blanks;
at least one goods carrier upon which multiple shaped-rod blanks are arranged and via which the shaped-rod blanks are shaped simultaneously.

31. The manufacturing system of claim 30, wherein the goods carrier comprises a shaping tool for shaping the shaped-rod blanks.

32. The manufacturing system of claim 31, wherein:
the goods carrier comprises at least two components connected to each other via a common swivel axle, and
the at least two components comprise receptacle areas for the shaped-rod blanks.

33. The manufacturing system of claim 30, wherein the goods carrier comprises a plurality of recesses, each recess in the plurality of recesses being configured to hold one shaped-rod blank.

34. The manufacturing system of claim 30, further comprising an insulation-stripping station configured to strip insulation at least partially from the shaped-rod blanks and support the goods carrier.

35. The manufacturing system of claim 34, wherein the insulation-stripping station comprises at least one rotating device for rotating the goods carrier.

36. The manufacturing system of claim 34, wherein the insulation-stripping station is arranged upstream of the shaping station in a production direction.

37. The manufacturing system of claim 30, further comprising:
a wire feeding device;
a separating device configured to separate the shaped-rod blanks;
at least one vertical notcher roller pair; and
at least one horizontal notcher roller pair.

38. The manufacturing system of claim 37, further comprising:
a first drive mechanism for driving the at least one vertical notcher roller pair; and/or
a second drive mechanism for driving the at least one horizontal notcher roller pair.

39. The manufacturing system of claim 38, wherein one of the at least one vertical notcher roller pair and the at least one horizontal notcher roller pair only has a blade, and the other of the at least one vertical notcher roller pair and the at least one horizontal notcher roller pair only has a support function.

40. The manufacturing system of claim 37, further comprising an encoder friction gear configured to define a distance that the conductor wire covers.
